(19) United States
(12) Patent Application Publication
(10) Pub. No.: US 2006/0231195 A1
(43) Pub. Date: Oct. 19, 2006

(54) Method for forming fine lines on gas permeable and moisture absorptive material

(75) Inventors: Ping-Yu Tsai, Hsinchu (TW); Yao-Hui Lu, Hsinchu (TW)

Correspondence Address: BRUCH H. TROXELL, SUITE 1404, 5205 LEESBURG PIKE, FALLS CHURCH, VA, 22041, US

(73) Assignee: Klaser Technology Inc.

(21) Appl. No.: 11/106,562

(22) Filed: Apr. 15, 2005

(51) Int. Cl. B32B 37/00

(52) U.S. Cl. 156/247

(57) ABSTRACT

A method for forming fine lines on a gas permeable and moisture absorptive material comprises the following steps: allowing a water-based resin layer to be spread on a molding plate with lines; allowing the water-based resin layer to be covered with a carrier made from a gas permeable and moisture absorptive materials; evaporating the water contained in the water-based resin layer; removing the molding plate after the water-based resin layer is hardened to be a solidified resin layer and combined with the carrier stably to cause the lines on the molding plate to be transferred onto the solidified resin layer to allow lines corresponding to the lines on the molding plate to be formed on the solidified resin layer.

### FIELD OF THE INVENTION

The present invention relates to a method for forming fine lines on a material, and more particularly to a method for forming fine lines on a gas permeable and moisture absorptive material.

### DESCRIPTION OF RELATED ART

Taiwan Patent No. 138,868 discloses the combination of a holographic sheet formation and a printing process. The method disclosed in the patent is to spread a layer of fluid resin on one face of a paper and to form a holographic image on the resin by means of a plastic molding. Thereafter, an electric beam is projected to harden the fluid resin to form a holographic pattern.

Taiwan Patent No. 592,950 discloses a solvent resistant laser holographic pattern film and manufacturing thereof, in which a plastic film is combined with a UV resin film to allow the UV resin film to be stuck closely on a metal wheel carved with a laser holographic pattern; and a UV light is used to illuminate on the UV resin film stuck closely with the metal wheel to cause the UV resin film to be hardened and combined closely with the plastic film; and the UV resin film is then separated from the metal wheel. Thereafter, the laser holographic pattern on the metal wheel is at last reproduced on the UV resin film.

A higher cost on materials and facilities and a higher consuming energy are surely needed in The manufacturing processes utilizing the electric beam or the UV light to illuminate the fluid resin to cause the fluid resin to be hardened to form the holographic pattern mentioned above, no matter what kind of material is used or environment is needed for the production operation.

The U.S. Pat. No. 5,939,177 discloses a holographically transferable image in which a heating and pressuring is used to transfer a metallized holographic image spread with an adhesive layer onto a package paper to cause the package paper to have a holographic image thereon. Therefore, the production cost is higher and manufacturing speed is lower because an adhesive is needed and heating and pressuring facilities are used while manufacturing.

The U.S. Pat. No. 6,679,968 entitled “Laser laminar structure and method of manufacturing the same” discloses a laser laminar structure, in which two layers of bonding resins are respectively spread on the top and the bottom faces of a laminar substrate, a layer of molding resin is then spread on each bonding layer, a layer of laser transparent film, on which fine lines printed with figures, characters or logos, is further stuck on the surface of each bonding resin to allow the corresponding laser image fine lines to be formed on the superficial portion of each molding resin. The fine lines formed on the surface of each molding resin is caused to harden after being baked with a high temperature illumination; a thermostable laser laminar product is finally formed after the laser transparent film is released. The production coast is higher and the manufacturing speed is lower because a bonding resin needs to be spread and a high temperature illumination baking facility is indispensable in the manufacturing mentioned above.

### SUMMARY OF THE INVENTION

For providing a method for forming fine lines on a gas permeable and moisture absorptive material, making use of the gas permeable and moisture absorptive characteristics of the material and needing no expensive material and facility, fine lines can be easily and quickly formed on the gas permeable and moisture absorptive material, the present invention is proposed.

The main object of the present invention is provide a method for forming fine lines on a gas permeable and moisture absorptive material, enabling the operation to be simpler and the fine lines transformation to be more quickly while manufacturing.

Another object of the present invention is to provide a method for forming fine lines on a gas permeable and moisture absorptive material, needing no expensive material and facility, it is economical.

Still another object of the present invention is to provide a method for forming fine lines on a gas permeable and moisture absorptive material, needing no environment polluting organic solvent, it is of environmental consciousness.

### BRIEF DESCRIPTION OF THE DRAWINGS

The present invention can be more fully understood by reference to the following description and accompanying drawings, in which:

FIGS. 1A to 1D are schematic views, respectively showing a structure in each step in a method for forming fine lines on a gas permeable and moisture absorptive material according to the present invention.

### DETAILED DESCRIPTION OF THE PREFERRED EMBODIMENTS

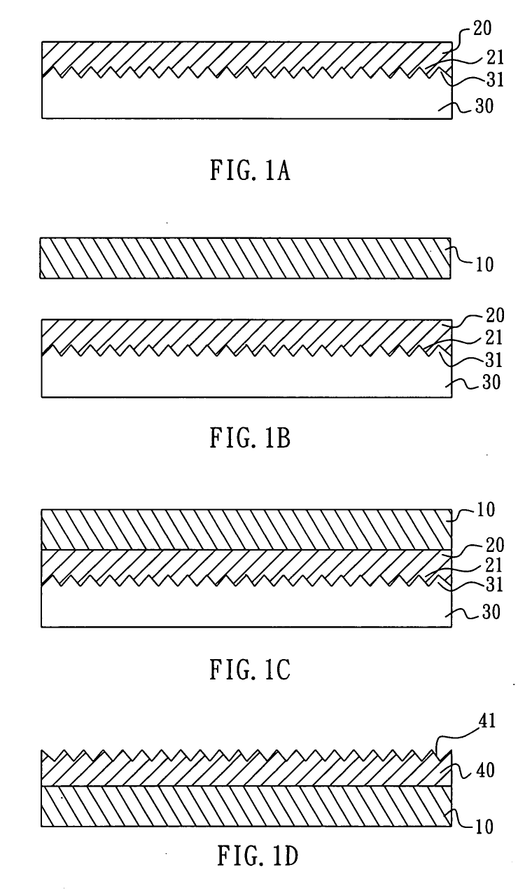

Please refer to FIGS. 1A to 1D. A method for forming fine lines on a gas permeable and moisture absorptive material according to the present invention comprises the following steps:
1. allowing a water based resin layer 20 such as polyvinyl alcohol resin to be spread on a molding plate 30 with transferred-to-be lines 31 to allow lines 21 corresponding to the lines 31 to be formed on the water-based resin layer 20, as FIG. 1A shows;
2. allowing the water-based resin layer 20 to be covered with a carrier 10 made from a gas permeable and moisture absorptive material, as FIGS. 1B and 1C shows;
3. allowing the water contained in the water-based resin layer 20 to be evaporated and carried away by means of heat energy or the gas permeable and the moisture absorptive characteristic of the carrier 10 itself, as FIG. 1C shows;
4. removing the molding plate 30 after the water based resin layer 20 is harden to be a solidified resin layer 40 so as to allow the lines 31 on the molding plate 30 to be transferred to the solidified resin layer 40 to cause the solidified resin layer 40 to have lines 41 corresponding to the lines 31 of the molding plate 30, as FIG. 1D shows.

The carrier 10 according to the present invention can be one of a variety of gas permeable and moisture absorptive materials, such as paper, cloth, wood, plastic film, leather, stone, concrete and rubber.

The molding plate 30 according to the present invention can be one of a variety of materials, such as metal, plastic film.

The gas permeable and moisture absorptive characteristics of the carrier 10 of the present invention are used to allow the water-based resin to be permeated into the gaps of the fibers of the carrier 10 when the water-based resin layer 20 is spread thereon. Broadening the evaporation area of the water can increase the evaporation efficiency. Therefore, the water contain in the water-based resin layer 20 can quickly and easily be carried away without needing to use expensive materials and facilities and the water-based resin layer 20 can stably be combined with the carrier 10 by means of the resin penetrated into the gaps of the fibers of the carrier 10. Thereby, the operation of the manufacturing of the transferring of the fine lines is simpler and faster. Besides, too large pressure exerted on the molding plate 30 and the water-based resin layer 20 is not needed according to the present invention, the lines 31 on the molding plate 30 can then be transferred to the water-based resin layer 20; the lines 31 on the molding plate 30 can rather not be damaged so that the molding plate 30 can be allowed to used repeatedly.

The water-based resin according to the present invention is made by taking pure water as a solvent to dissolve resin into it and without using an organic solvent that is pollutant to the environment.

The water in the water-based resin is caused to evaporate in the manufacturing process according to the present invention, only water vapor that is harmless to the environment is yielded and no organic solvent gas that is pollutant to the environment can be yielded so that it is rather of environmental consciousness.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for forming fine lines on a gas permeable and moisture absorptive material, comprising:
(1) allowing a water-based resin layer to be spread on a molding plate with lines to allow lines corresponding to said lines of said molding plate to be formed on said water-based resin layer;
(2) allowing said water-based resin layer to be covered with a carrier made from a gas permeable and moisture absorptive materials;
(3) allowing the water contained in the water-based resin layer to be carried away;
(4) removing said molding plate after said water-based resin layer is harden to be a solidified resin layer so as to allow said lines on said molding plate to be transferred to said solidified resin layer to cause the solidified resin layer to have lines corresponding to said lines of said molding plate.

2. The method according to claim 1, wherein heat energy is utilized to evaporate said water in said step (2).

3. The method according to claim 1, wherein said carrier is utilized to absorb said water and further to cause said absorbed water to be evaporated in said step (2).

4. The method according to claim 1, wherein said carrier is paper.

5. The method according to claim 1, wherein said carrier is cloth.

6. The method according to claim 1, wherein said carrier is wood.

7. The method according to claim 1, wherein said carrier is plastic film.

8. The method according to claim 1, wherein said carrier is leather.

9. The method according to claim 1, wherein said carrier is stone.

10. The method according to claim 1, wherein said carrier is concrete.

11. The method according to claim 1, wherein said carrier is rubber.

12. The method according to claim 1, wherein said molding plate is metal.

13. The method according to claim 1, wherein said molding plate is plastic film.
